(19) United States
(12) Patent Application Publication
(10) Pub. No.: US 2003/0120660 A1
(43) Pub. Date: Jun. 26, 2003

(54) Consumer-centric context-aware switching model

(76) Inventors: L. Michael Maritzen, Fremont, CA (US); Kiyo Niwa-San, Haworth, NJ (US); Harold Aaron Ludtke, San Jose, CA (US)

Correspondence Address: Valley Oak Law, #106, 5655 Silver Creek Valley Road, San Jose, CA, 95138, US

(21) Appl. No.: 10/017,181

(22) Filed: Dec. 7, 2001

(51) Int. Cl. G06F 7/00

(52) U.S. Cl. 707/100

(57) ABSTRACT

A system and method for a context-aware switching model enabled between different access points such as web sites are described. The invention allows a user to be automatically transferred securely to another site from the current site without requiring intervention from the user, such as redundant entry of information. In another embodiment, the invention can also be utilized to switch from one application to another application. The invention also is capable of gathering context sensitive information and passing this context-sensitive information to another location. In one embodiment, the invention operates in conjunction with a secured transaction exchange, automatic population of fields, digital rights management, controlled content access, and the like. In one embodiment, context data is captured on a transaction device; the context data is stored on a storage device; and the context data is distributed from the storage device to a remote location.

### CROSS REFERENCE TO RELATED APPLICATIONS

The present application claims benefit of U.S. Provisional Patent Application No. 60/XXX,XXX filed on Dec. 7, 2000, entitled “Method and Apparatus for a Platform-Independent Consumer-Centric Automated Context-Aware Switching Model Between Different Internet-Enabled Sites” listing the same inventors, the disclosure of which is hereby incorporated by reference.

### BACKGROUND OF THE INVENTION

Electronic commerce is achieving widespread use. Transactions are performed everyday over the Internet and through point of sale (POS) or bank systems. Such transactions are typically performed after the person requesting access to some information is authenticated and access is given to that person's private information, such as financial, medical, or other type of restricted records. Present systems are designed to maintain the integrity of the user's credit card, debit card, and account number. However, no measures are taken to ensure the secure authentication of the user in order to prevent unauthorized access by a potential thief.

Presently, applications providing access to sensitive information are based upon information that a potential thief may appropriate with relative ease. For example, some of the information presently required to grant access to sensitive material, such as a person's Social Security Number, date of birth, or mother maiden's name, is readily available. Once a potential thief collects any two pieces of this information, the thief may obtain access to the person's financial, medical, or other private information. In addition, most secure access systems are set up to divulge a person's entire file, once they receive the appropriate password and/or correct answers to the security questions. Therefore, a potential thief may steal the person's identity and ruin that person's credit.

Further, the traditional non-Internet area of digital rights management (DRM) is complex, and the Internet-enabled digital content DRM area is even more complex. Current DRM activities typically relate to post-sales and post-fulfillment DRM and associated payment settlement. By delaying DRM to post-sales and post-fulfillment, the merchant is vulnerable to fraud and lack of sufficient funds to cover purchases.

Further, when users traverse different websites, user information is not transferred to the current website unless prior arrangements are made between the current and the prior websites.

### SUMMARY OF THE INVENTION

A system and method for a context-aware switching model enabled between different access points such as web sites are described. The invention allows a user to be automatically transferred securely to another site from the current site without requiring intervention from the user, such as redundant entry of information. In another embodiment, the invention can also be utilized to switch from one application to another application. The invention also is capable of gathering context sensitive information and passing this context-sensitive information to another location. In one embodiment, the invention operates in conjunction with a secured transaction exchange, automatic population of fields, digital rights management, controlled content access, and the like. In one embodiment, context data is captured on a transaction device; the context data is stored on a storage device; and the context data is distributed from the storage device to a remote location.

### BRIEF DESCRIPTION OF THE DRAWINGS

The present invention is illustrated by way of example and not limitation in the figures of the accompanying drawings, in which like references indicate similar elements and in which:

FIG. 1 is a simplified block diagram of one embodiment of a secure transaction system.

FIG. 2 is a simplified block diagram of one embodiment of a privacy card for a personal transaction device.

FIG. 3 is a simplified block diagram of one embodiment of a digital wallet for a personal transaction device.

FIG. 4 is a simplified block diagram of one embodiment of a secure transaction system showing a point-of-sale terminal.

FIG. 5 is a simplified block diagram of one embodiment of a transaction privacy clearing house.

FIG. 6 is a simplified representation of one embodiment of embedded content.

FIG. 7 is a simplified representation of one embodiment of a header within embedded content.

FIG. 8 is a simplified representation of one embodiment of a context data system.

FIG. 9 illustrates a flow diagram for performing a transaction with context data.

### DETAILED DESCRIPTION

In the following descriptions for the purposes of explanation, numerous details are set forth in order to provide a thorough understanding of the present invention. However, it will be apparent to one skilled in the art that these specific details are not required in order to practice the present invention. In other instances, well-known electrical structures or circuits are shown in block diagram form in order not to obscure the present invention unnecessarily.

A system and method for a context-aware switching model enabled between different access points such as web sites are described below. The invention allows a user to be automatically transferred securely to another site from the current site without requiring intervention from the user, such as redundant entry of information is described below. In another embodiment, the invention can also be utilized to switch from one application to another application. The invention also is capable of gathering context sensitive information and passing this context-sensitive information to another location. In one embodiment, the invention operates in conjunction with a secured transaction exchange, automatic population of fields, digital rights management, controlled content access, and the like.

Security of the user's identity may be achieved in a variety of ways. In one embodiment, a single trusted location. For example, a transaction privacy clearing house (TPCH) contains user data. The user interfaces with the TPCH using the user's transaction device. The user therefore does not fill out online the electronic purchase forms at every product vendor's website. The TPCH acts as a financial transaction middleman, stripping off user identity information from transactions. As a result, the user's private information is not stored in several databases across the Internet and in private business networks. The secure locations where the financial data is stored minimizes the possibilities that hackers can access the data or accidental releases of the data can occur.

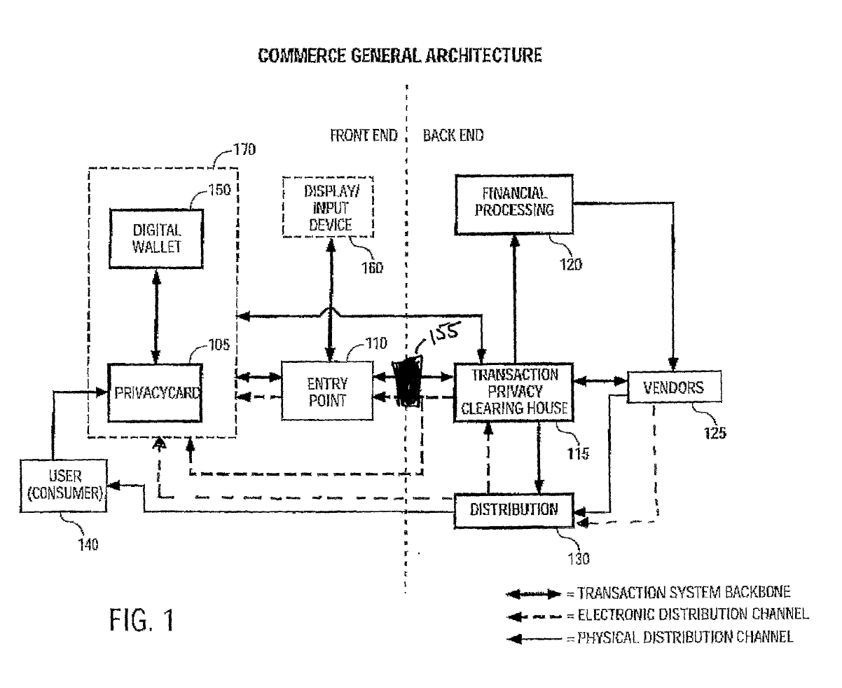

FIG. 1 is a simplified block diagram of one embodiment of a secure transaction system, which may be used in electronic commerce. As illustrated in FIG. 1, in this embodiment, a transaction privacy clearing house (TPCH) 115 interfaces a user (consumer) 140 and a vendor 125.

In this particular embodiment, a personal transaction device (PTD) 170, e.g., a privacy card 105, or a privacy card 105 coupled to a digital wallet 150, is used to maintain the privacy of the user while enabling the user to perform transactions. The personal transaction device 170 may include a privacy card, a digital wallet, a point of sale terminal, a laptop computer, a desktop computer, a PDA, or any other device under the control of the user 140.

The personal transaction device 170 provides an interface for the user to exchange information. This exchange of information may include but is not limited to the user 140 receiving audio and/or visual content, instructions, requests, and the like from the personal transaction device 170. Further, this exchange of information may also include but is not limited to the personal transaction device 170 receiving instructions, payment authorization, authentication, and the like from the authorized user 140. In one embodiment, the personal transaction device 170 may be configured to closely resemble a standard credit card. More particularly the card may have a magnetic stripe that functions similarly to standard credit cards. In addition, the personal transaction device 170 may also contain wireless data communication, data storage and communication protocols for selectively communicating with outside devices such as a digital wallet described herein, point-of-sale terminal, or personal computer, and digital televisions.

In one embodiment, the personal transaction device 170 is configured to receive embedded content. Embedded content includes data information and header information containing various parameters relating to the data information.

In one embodiment, the personal transaction device 170 is configured to manage and control access to content and/or transactions received by individual accounts associated with the users of the personal transaction device.

In an alternate embodiment, account management and control of access to content is achieved through the PTD 170. The PTD 170 may assign particular accounts with varying levels of content access and may place accounts into convenient groupings for account management.

In one embodiment, the personal transaction device 170 is configured automatically handle contextual information and share this information with appropriate parties.

In an alternate embodiment, the PTD 170 may be any suitable device that allows unrestricted access to TPCH 115. In one embodiment, the personal transaction device 170 may include a full screen that covers one side of the card. Alternately, in one embodiment in which the personal transaction device 170 is one embodiment of a privacy card, the privacy card may be coupled to device such as a digital wallet described herein, that provides a display. In one embodiment, the screen may be touch sensitive and be used for data input as well as output. In one embodiment, a user authentication mechanisms such as a fingerprint recognition for other mechanism may be built directly into the card. Furthermore, the privacy card may have a wireless communication mechanism for input and output.

A variety of user interfaces may be used. In one embodiment, and input device may be incorporated on the transaction device. Alternately or supplemental and input device may be coupled to the transaction device. In one embodiment, and input device may be provided on a digital wallet coupled to a privacy card. User inputs may be provided on the point-of-sale terminals including a personal point-of-sale terminal.

The personal transaction device information is provided to the TPCH 115 that then indicates to the vendor 125 and the user 140 approval of the transaction to be performed. The transaction device utilizes an identification to maintain confidentiality of the user's identity by applying the transaction device identification and the identity of the entity performing the transaction. Thus, all transactions, from the vendor's perspective, are performed with the transaction device.

In order to maintain confidentiality of the identity of the user 140, the transaction device information does not provide user identification information. Thus, the vendor 125 or other entities do not have user information but rather transaction device information. The TPCH 115 maintains a secure database of transaction device information and user information. In one embodiment, the TPCH 115 interfaces to at least one financial processing system 120 to perform associated financial transactions, such as confirming sufficient funds to perform the transaction, and transfers to the vendor 125 the fees required to complete the transaction. In addition, the TPCH 115 may also provide information through a distribution system 130 that, in one embodiment, can provide a purchased product to the user 140, again without the vendor 125 knowing the identification of the user 140. In an alternate embodiment, the financial processing system 120 need not be a separate entity but may be incorporated with other functionality. For example, in one embodiment, the financial processing system 120 may be combined with the TPCH 115 functionality.

In one embodiment, the financial processing system (FP) 120 performs tasks of transferring funds between the user's account and the vendor's account for each transaction. In one embodiment, the presence of the TPCH 115 means that no details of the transactions, other than the amount of the transactions and other basic information, are known to the FP 120. The TPCH 115 issues transaction authorizations to the FP 120 function on an anonymous basis on behalf of the user over a highly secure channel. The FP 120 does not need to have many electronic channels receiving requests for fund transfer, as in a traditional financial processing system. In one embodiment, a highly secure channel is set up between the TPCH 115 and the FP 120; thus, the FP 120 is less vulnerable to spoofing.

In one embodiment, the TPCH 115 contacts the FP 120 and requests a generic credit approval of a particular account. Thus, the FP 120 receives a minimal amount of information. In one embodiment, the transaction information, including the identification of goods being purchased with the credit need not be passed to the FP 120. The TPCH 115 can request the credit using a dummy charge ID that can be listed in the monthly credit statement sent to the user, so that the user can reconcile his credit statement. Further, the personal transaction device 105 can include functionality to cause the credit statement to convert the dummy charge ID back to the transactional information so that the credit statement appears to be a conventional statement that lists the goods that were purchased and the associated amount charged.

A display input device 160 (shown in phantom) may be included to enable the user, or in some embodiments the vendor 125, to display status and provide input regarding the PTD 105 and the status of the transaction to be performed.

In yet another embodiment, an entry point 110 interfaces with the personal transaction device 170 and also communicates with the TPCH 115. The entry point 110 may be an existing (referred to herein as a legacy POS terminal) or a newly configured point of sale (POS) terminal located in a retail environment. The user 140 uses the PTD 170 to interface to the POS terminal in a manner similar to how credit cards and debit cards interface with POS terminals. The entry point 110 may also be a public kiosk, a personal computer, or the like.

In another embodiment, the PTD 170 interfaces through a variety of interfaces including wireless interfaces such as BlueTooth and infrared transmission; contactless transmission such as FeliCa and AmexBlue; and plug-in port transmission such as USB and RS-232C. A stand-in processor 155 (STIP) can interface with the PTD 170 in the event that the connection between the front end and the back end is disrupted for any reason. This way, the PTD 170 can gain authorization for a specified floor limit without necessarily receiving authorization from the back end. Further, this limits the amount of authorization thus minimizing fraud and insufficient funds.

The system described herein also provides a distribution functionality 130 whereby products purchased via the system are distributed. In one embodiment, the distribution function 130 is integrated with the TPCH 115 functionality. In an alternate embodiment, the distribution function 130 may be handled by a third party. Utilizing either approach, the system ensures user privacy and data security. The distribution function 130 interacts with the user through PTD 130 to ship the product to the appropriate location. A variety of distribution systems are contemplated, for example, electronic distribution through a POS terminal coupled to the network, electronic distribution direct to one or more privacy cards and/or digital wallets, or physical product distribution. In one embodiment for physical product distribution, an “anonymous drop-off point”, such as a convenience store or other ubiquitous location is used. In another embodiment, it involves the use of a “package distribution kiosk” that allows the user to retrieve the package from the kiosk in a secure fashion. However, in one embodiment, the user may use PTD 170 to change the shipping address of the product at any time during the distribution cycle.

A user connects to and performs transactions with a secure transaction system (such as shown in FIG. 1) through a personal transaction device (PTD) that has a unique identifier (ID). In one embodiment, a privacy card is used. In an alternate embodiment a digital wallet is used. In yet another alternate embodiment, a privacy card in conjunction with a digital wallet are used.

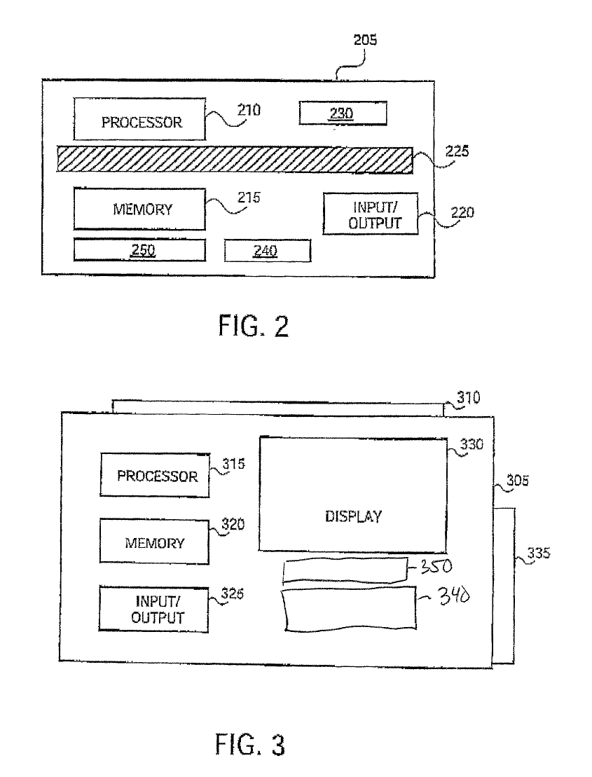

FIG. 2 is a simplified block diagram of one embodiment of a privacy card 205 for a personal transaction device. As illustrated in FIG. 2, in one embodiment, the card 205 is configured to be the size of a credit card. The privacy card includes a processor 210, memory 215 and input/output logic 220. The processor 210 is configured to execute instructions to perform the functionality herein. The instructions may be stored in the memory 215. The memory is also configured to store data, such as transaction data and the like. In one embodiment, the memory 215 stores the transaction ID used to perform transactions in accordance with the teachings of the present invention. Alternately, the processor may be replaced with specially configured logic to perform the functions described here.

The input/output logic 220 is configured to enable the privacy card 205 to send and receive information. In one embodiment, the input/output logic 220 is configured to communicate through a wired or contact connection. In another embodiment, the logic 220 is configured to communicate through a wireless or contactless connection. A variety of communication technologies may be used.

In one embodiment, a display 225 is used to generate bar codes scanable by coupled devices and used to perform processes as described herein. The privacy card 205 may also include a magnetic stripe generator 240 to simulate a magnetic stripe readable by devices such as legacy POS terminals.

In one embodiment, biometric information, such as fingerprint recognition, is used as a security mechanism that limits access to the card 205 to authorized users. A fingerprint touch pad and associated logic 230 is therefore included in one embodiment to perform these functions. Alternately, security may be achieved using a smart card chip interface 250, which uses known smart card technology to perform the function.

Memory 215 can have transaction history storage area. The transaction history storage area stores transaction records (electronic receipts) that are received from POS terminals. The ways for the data to be input to the card include wireless communications and the smart card chip interface which functions similar to existing smart card interfaces. Both of these approaches presume that the POS terminal is equipped with the corresponding interface and can therefore transmit the data to the card.

Memory 215 can also have user identity/account information block. The user identity/account information block stores data about the user and accounts that are accessed by the card. The type of data stored includes the meta account information used to identify the account to be used.

In another embodiment, the memory 215 also stores the embedded content received by the privacy card.

In another embodiment, the memory 215 also stores the account management information such as categories and the account access levels of content.

In another embodiment, the memory 215 also stores the contextual information gathered by the personal transaction device.

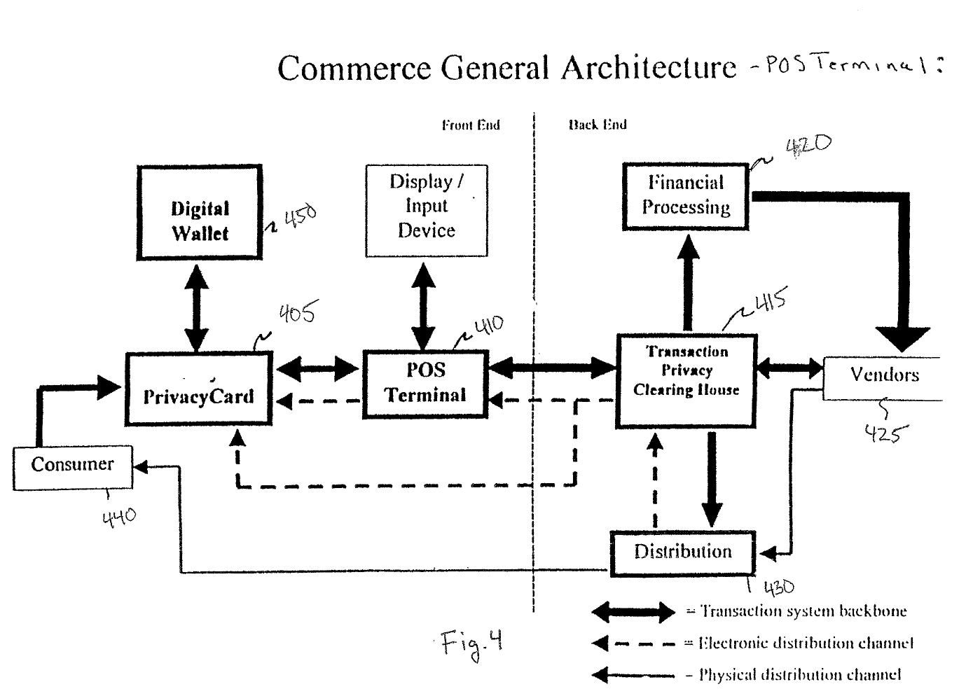

FIG. 3 is a simplified block diagram of one embodiment of a digital wallet 305 for a personal transaction device. As illustrated in FIG. 3, the digital wallet 305 includes a coupling input 310 for the privacy card 205, processor 315, memory 320, input/output logic 225, display 330, peripheral port 335, account management module 340, and context sensitive data module 350. The processor 315 is configured to execute instructions, such as those stored in memory 320, to perform the functionality described herein. Memory 320 may also store data including financial information, eCoupons, shopping lists, embedded content, and the like. The digital wallet may be configured to have additional storage. In one embodiment, the additional storage is in a form of a card that couples to the device through peripheral port 310.

In one embodiment, the account management module 340 stores account management information and access control data related to each individual account on the memory 320.

The context sensitive data module 350 coordinates the capture of context data, the storage of context data, and the distribution of context data.

In one embodiment, the privacy card 205 couples to the digital wallet 305 through port 310; however, the privacy card 205 may also couple to the digital wallet 305 through another form of connection including a wireless connection.

Input/output logic 325 provides the mechanism for the digital wallet 305 to communicate information. In one embodiment, the input/output logic 325 provides data to a point-of-sale terminal or to the privacy card 205 in a pre-specified format. The data may be output through a wired or wireless connection.

The digital wallet 305 may also include a display 330 for display of status information to the user. The display 330 may also provide requests for input and may be a touch sensitive display, enabling the user to provide the input through the display.

The physical manifestation of many of the technologies in the digital wallet 305 will likely be different from those in the privacy card 205, mainly because of the availability of physical real estate in which to package technology. Examples of different physical representations would include the display, fingerprint recognition unit, etc.

The transaction device enhances security by authenticating the user of the card prior to usage such that if a card is lost or stolen, it is useless in hands and in an unauthorized person. One means of authentication is some type of PIN code entry. Alternatively, authentication may be achieved by using more sophisticated technologies such as a biometric solution. This biometric solution can include fingerprint recognition, voice recognition, iris recognition, and the like. In addition, in one embodiment in which multiple transaction devices are used, it may be desirable to configure the first device to enable and program the second device in a secure manner. Thus, the means of communication between the first device in the second device may include mutual device verification said that can unauthorized first device may not be used to enable a particular second device that does not belong to the same or authorized user.

In one embodiment, the transaction device, point of sale terminals and/or TPCH may function to verify the authenticity of each other. For example the transaction device may be configured to verify the legitimacy of the point-of-sale terminal and/or TPCH. A variety of verification techniques may be used. For example, listen device with account and/or access issues may be maintained. For example, in one embodiment, the public key infrastructure may be used to verify the legitimacy of the user.

Communication protocols include those that allow the digital wallet to specify which of several possible data structures to use for a transaction and communication protocols that allow the digital wallet and other devices to securely share data with the transaction device. The transaction device may represent a single account such as a particular credit card, or it may represent multiple accounts such as a credit card, telephone card, and debit card.

In one embodiment, the transaction device is intended to be the means by which the user interfaces with the invention. In one embodiment, the transaction device stores e-commerce related data on behalf of the user including transaction histories, meta account information needed to carry out a transaction using the transaction privacy clearinghouse function of the system, and various content. In one embodiment, the meta account information may be an extraction of the user's real identity as opposed to the actual user's name, address, etc. For example, the TPCH keeps records of the user's real bank account numbers, but assigned a different number for use by retailers and point-of-sale terminals. For example, and actual Bank Account No. may be 1234 0000 9876 1423 could be represented as 9999 9999 9999 9999. This number, in association with the transaction card's identification, could enable the TPCH to know that the bank account No. 1234 0000 9876 1423 was actually the account being used.

The purpose of this data is to abstract the user's identity while at the same time providing the necessary information for the transaction to be completed.

In one embodiment, the personalization process of the transaction device may be as described below. In this example, the transaction device is a digital wallet. The user turns on the transaction device. This can be accomplished by touching the finger print recognition pad or simply turning a switch. The transaction device performs at start a procedure, and attacks that it has not yet been personalized. Thus, it first prompt the user to enter the secret pin code. If the pin code entry fails, the user is prompted again. Ideally the user is given a finite number of chances to enter the data. After the last failure, the device may permanently disabled itself and thus becomes useless. It may also display in message requesting that the transaction device be returned to an authorized facility.

Assuming a successful pin code entry, the user may then be prompted to enter several of the security questions ever entered into the transaction device at processing center. Some of these questions might require data entry, and others might be constructed as simple multiple-choice, with both the correct as well as incorrect answers supplied. Assuming successful response to these questions, the user may then be prompted to enter secure personal identification information such as fingerprint data. In one embodiment, in which the fingerprint data is used, the user is prompted to enter fingerprint data by successively pressing one or more fingers against the recognition pad. The device prompt the user for each fingerprint that must be entered, for example, using a graphical image of a hand with the indicated finger.

The fingerprint data entry process may be performed at least twice to confirm that the user has entered the correct data. If confirmation succeeds, the device writes the fingerprint image data into their right once memory, or other memory that is protected from accidental modification. If confirmation fails, the user is prompted to start over with entry. Failure to reliably enter the fingerprint data after a finite number of tries will result in the device permanently disabled itself, and optional he providing an on-screen message to the user to go to secure processing facility such as a bank to complete the process. After successful personalization, the device is then ready to be used for the initial set of services that the user requested during the registration process. Once the device has been initialized for secure transactions, additional services could be downloaded to the device.

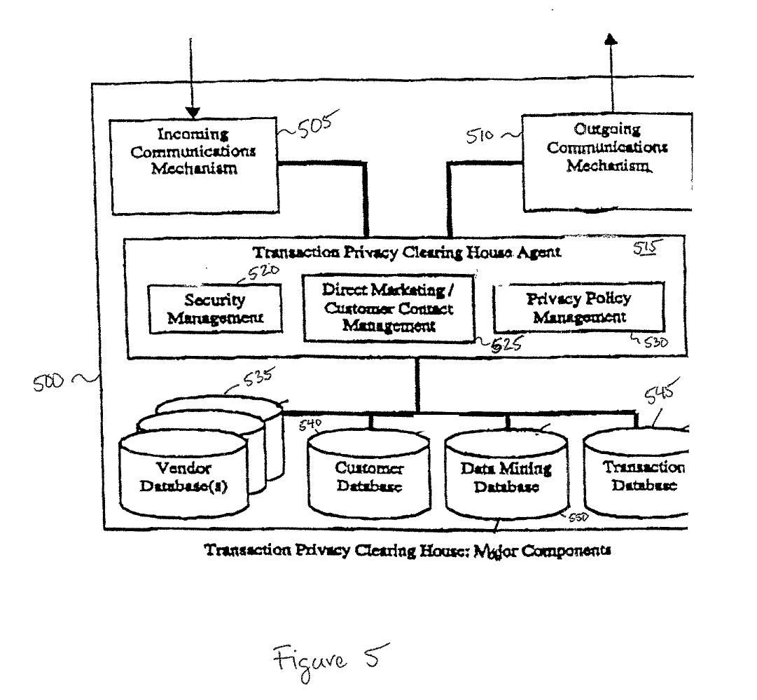

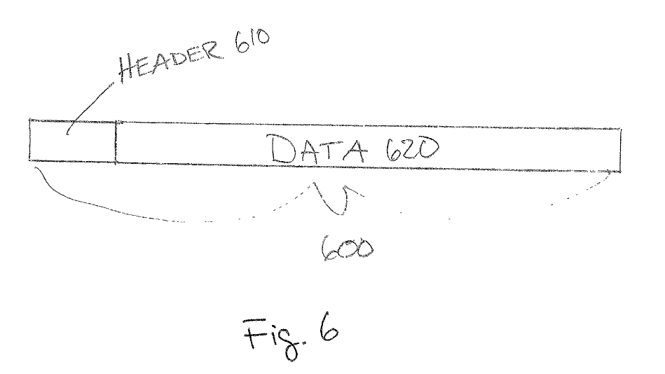

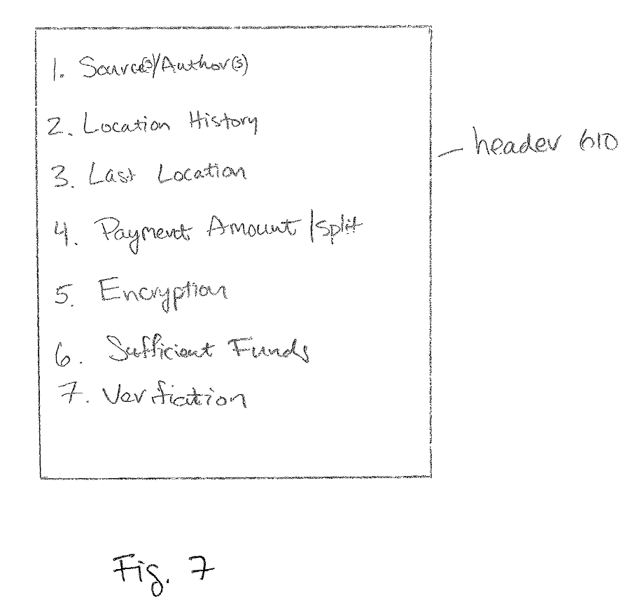

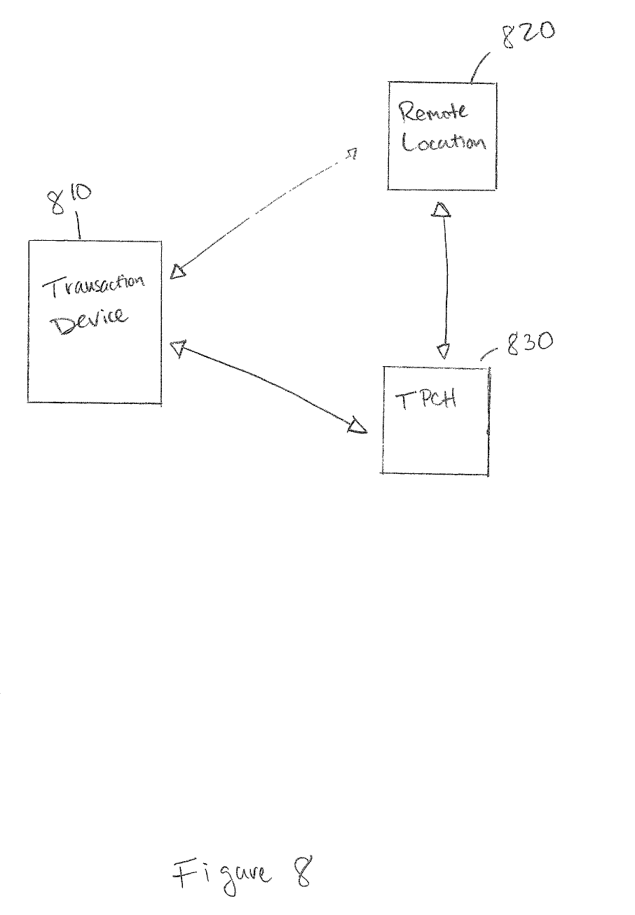

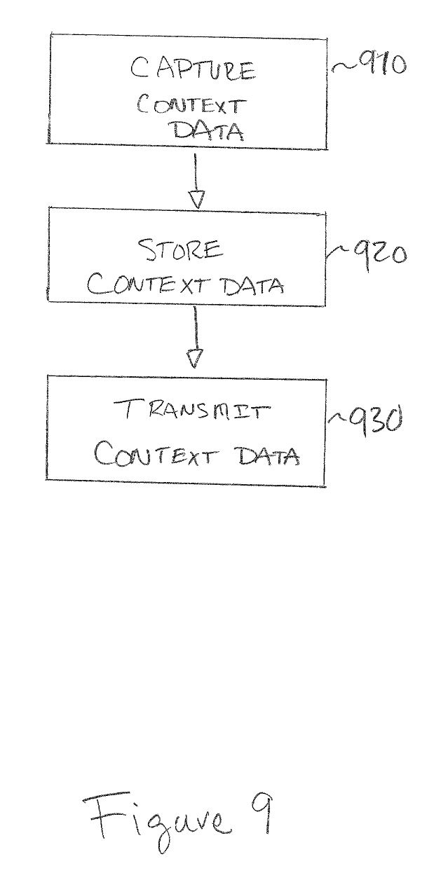

One embodiment of the system that utilizes a point-of-sale terminal is shown in FIG. 4. In this embodiment, the privacy card 405 interfaces with the point-of-sale terminal 410 and that point of sale terminal 410 communicates with that TPCH 415. That TPCH 415 interfaces with the financial processing system 420, the vendor 425 and the distribution system 430. The point-of-sale terminal may be an existing or newly configured point-of-sale terminal located in a retail environment. The user 440 uses the privacy card 405 to interface to the point-of-sale terminal a manner similar to how credit cards and debit cards interface with point-of-sale terminals. Alternately, a digital wallet 450 may be used by itself or with the privacy card 405 to interface to the point-of-sale terminal 410. Alternately, a memory device may be utilized solely as the interface with that point-of-sale terminal 410.

One embodiment of the TPCH is illustrated in FIG. 5. In one embodiment, the TPCH 500 is located at a secure location and is accessible to the transaction device. The TPCH 500 functions to provide the user with authorization to perform transactions without compromising the user's identity. The TPCH 500 may be embodied as a secure server connected to the transaction device in some form of direct connection or alternately a format in direct connection over the Internet or point-of-sale network.

Incoming communications mechanism 505 and outgoing communications mechanism 510 are the means of communicating with external retailers and vendors, as well as the transaction device such as the digital wallet. A variety of communication devices may be used, such as the Internet, direct dial-up modem connections, wireless, cellular signals, etc.

The TPCH agent 515 handles system management and policy control, informs their core functionality of the TPCH 500. In one embodiment, within the entire system, there is one clearinghouse agent, which resides permanently at the clearinghouse. Among the responsibilities handled by the agent include internal system management functions such as data mining, financial settlement and allocation of payments to internal and external accounts, embedded content management, and registration of new users joining the system.

The security management functions 520 ensure secure communications among the component internal to the TPCH 500 and the entities external to the TPCH 500. This function includes participating in secure communications protocols to open and maintain secure connections. This ensures that only authorized entities are allowed to access to data and that only authorized transaction devices can execute transactions against a user's account.

The TPCH agent 515 also provides a direct marketing and customer contact service 525, which in one embodiment is a data access control mechanism and maintain separate, secure access between various client and their databases. The data access control mechanism ensures that vendors have access only to the appropriate data in order to carry out the tasks of the system. One of the key features at the TPCH 500, the ability to carry out focused direct marketing while maintaining the privacy and identity protection of consumer, is handled by this mechanism.

The TPCH agent 515 can be configured to actively looking for content on behalf of the user as well as filter out unwanted incoming information. In one embodiment, the data may be described by XML and the agent may operate via Java applets.

One embodiment of content which can be distributed within the secure transaction system is shown in FIG. 6. Embedded content 600 includes header information 610 and data information 620. In one embodiment, the embedded content 600 is distributed from the vendor 125 (FIG. 1) to the user 140 (FIG. 1). In another embodiment, the content 600 is propagated directly from end user to end user. In another embodiment, the embedded content 600 is compiled from more than one vendor 125.

In each of these embodiments, the embedded content 600 can be traced back to the originating vendor. The header 610 is attached to the data 620 and cannot be removed. The header 610 describes the various attributes of the associated data 620. The data 620 may include audio representations, visual representations, audio/visual representations, software applications, textual data, graphical data, or the like. For example, the content 600 may represent an album, song, song segment, movie, or movie segment.

FIG. 7 illustrates a partial list of attributes stored within the header 610 and associated with the data 620. In one embodiment, the partial list of attributes includes source(s)/author(s), location history, current location, payment amount/split, and encryption. The source(s)/author(s) represents the originating creator of the associated data. There may be multiple sources/authors for each attached associated data.

The location history describes the physical locations the embedded content has been stored on. For example, each time the embedded content is transferred to a different media, the location history saves the location information of the new location and archives the past locations. The current location of the embedded content is stored in another location for easy access.

The payment amount/split represents the amount of money that is transferred to the source(s)/author(s) each time the embedded content is utilized on a new media device. If there are more than one source/author, the amount of money collected can be split amongst the sources/authors. The encryption portion of the header 610 represents the type of encryption selected to either render the data within the embedded content useful or meaningless. The encryption portion also includes rules that describe when the data is encrypted or decrypted.

FIG. 8 illustrates one embodiment of the invention. In one embodiment, the invention includes a transaction device 810, a remote location 820, and a transaction privacy clearing house (TPCH) 830. The transaction device 810 is similar to the prior transaction device 170 (FIG. 1). In one embodiment, the transaction includes a context sensitive data module 350 for handling the context data functions. In one embodiment, the resulting context data is stored as a single relational object. This context data may be stored within memory on the transaction device 810. In another embodiment, the context data may be stored within the TPCH 830. The remote location 820 may include a web site which provides storage, content, support, service, and/or product.

In one embodiment, the transaction device 810 is capable of communicating with the remote location 820 through the TPCH 830. In this embodiment, the context data may reach the remote location via the TPCH 830. The context data can either be transmitted from the transaction device 810 thus reaching the remote location 820 via the TPCH 830 or given instructions from the transaction device 810 to have the TPCH 830 transmit them to the remote location 820. In another embodiment, the transaction device may directly contact the remote location 810 and transmit the context data directly to the remote location 820.

FIG. 9 illustrates a flow diagram representing one embodiment of the context sensitive data module. The flow diagram and the corresponding functional blocks are shown for exemplary purposes and is not intended to limit the scope of the invention. The functional blocks may occur in any order. Further, there may be additional or fewer functional blocks.

In Block 910, context data is captured. In one embodiment, the URL information is captured both within one web site and across multiple web sites. In another embodiment, information entered by the user is captured. This information entered by the user includes text fields, selected boxes, profile information, and/or financial information. In yet another embodiment, the context data includes embedded content.

In Block 920, the context data is stored. In one embodiment, the context data is stored as a single relational object. In another embodiment, the context data is stored as a multi relational object. The context data is stored within the transactional device in one embodiment. In another embodiment, the context data is stored outside the transactional device such as within the TPCH.

In Block 930, the context data is transmitted to other locations and/or devices which are able to utilize the context data. In one embodiment, the user pre-selects which entities are authorized to receive the context data. In addition, the user also pre-selects which information within the context data is available for other entities to receive. This way, once these distribution preferences are set up, the distribution of context data is automatic from the user's perspective. In another embodiment, in addition to the user pre-selecting distribution options, the user also confirms or verifies distribution when an unauthorized entity requests context data prior to distribution. In another embodiment, the user also confirms or verifies distribution of highly personal context data prior to distribution. The highly personal context data may include financial information, credit card information, social security number, home address, driver license number, and the like.

The following is a specific example of one embodiment of the invention for exemplary purposes. In this example, there is a user who is having problems with their software product, XYZ. The user then goes to the web site for the software product XYZ, and executes a series of FAQ-driven troubleshooting navigational operations using the online help and diagnostics function of the site. However, the user unfortunately does not have success with the diagnostics and resolution. At this point, the user is transferred to a call center chat room, where the technician has received the full context data. The full context data includes navigational selections, answers to questions, user profile data, and the like. The user and technician are able to proceed with more detailed discussion and diagnostics without having the user repeat information already provided and/or available from the context data. The call center technician has the complete navigation and contextual information, which resulted from the user's preliminary web site-executed attempt at self-diagnosis. With a minimum of time and effort, the technician is able to glean information from the user's prior self-diagnosis and benefit from the user's prior self-diagnosis to quickly resolve the issue.

Another specific example is presented for exemplary purposes. A user enters personal information such as name, mailing address, and age, when requesting information from website #1. The user leaves website #1 and visits website #2. Subsequently, the user visits website #3. The progression of the user from website #1 through website #3 may occur during different sessions. Additionally, the progression of the user from website #1 through website #3 may occur without linking or cooperation between any of these websites.

The website #3 requests personal information such as name and mailing address from the user. In response to the user's pre-selection, context data including the user name and mailing address is automatically sent to website #3. This saves the user from re-entering this personal information.

Further, website #3 also requests the context data including the user's website visitation history. In response to the user's pre-selection of allowable context data to be distributed, the user is prompted to approve this distribution of the user's website visitation history. The user is able to decide whether to allow this context data to be distributed to website #3. In another embodiment, based on the user's pre-selection of allowable context data to be distributed, the distribution of context data including the user's website visitation history may be denied without further inquiry to the user.

In another embodiment, the website #3 offers the user a discount towards the purchase of services and/or products in exchange for the context data of the user's website visitation history.

The foregoing descriptions of specific embodiments of the invention have been presented for purposes of illustration and description.

They are not intended to be exhaustive or to limit the invention to the precise embodiments disclosed, and naturally many modifications and variations are possible in light of the above teaching. The embodiments were chosen and described in order to explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

1. A transaction device for interfacing with a user comprising:
a. a context data module for capturing and distributing context data; and
b. a storage device connected to the context data module for storing the context data.

2. The transaction device according to claim 1 further comprising an interface connected to the context data module for receiving a pre-selected distribution preference from the user.

3. The transaction device according to claim 2 wherein the context data module distributes the context data in response to the pre-selected distribution preference.

4. The transaction device according to claim 1 further comprising an interface connected to the context data module for receiving a pre-selected context data preference from the user.

5. The transaction device according to claim 4 wherein the context data module captures the context data in response to the pre-selected context data preference.

6. The transaction device according to claim 1 wherein the context data includes personal contact information entered by the user.

7. The transaction device according to claim 1 wherein the context data includes personal financial information entered by the user.

8. The transaction device according to claim 1 wherein the context data includes website visitation history of the user.

9. A method comprising:
a. capturing context data on a transaction device;
b. storing the context data on a storage device; and
c. distributing the context data from the storage device to a remote location.

10. The method according to claim 9 wherein the context data includes personal contact information entered by a user.

11. The method according to claim 9 wherein the context data includes personal financial information entered by a user.

12. The method according to claim 9 wherein the context data includes a website visitation history of a user.

13. The method according to claim 9 wherein the remote location is a website.

14. The method according to claim 9 wherein the remote location is a transaction privacy clearing house.

15. The method according to claim 9 wherein the storage device is within the transaction device.

16. The method according to claim 9 wherein the storage device is outside the transaction device.

17. The method according to claim 9 further comprising pre-selecting the context data for distribution.

18. A method comprising:
a. capturing context data on a transaction device in response to a user input; and
b. receiving the context data in a remote location thereby obviating a redundant user input.

19. The method according to claim 18 further comprising pre-selecting the context data for capturing.

20. The method according to claim 18 wherein the redundant user input is user profile information.

21. The method according to claim 18 wherein the redundant user input is a website history.

22. A computer-readable medium having computer executable instructions for performing a method comprising:
a. capturing context data on a transaction device;
b. storing the context data on a storage device; and
c. distributing the context data from the storage device to a remote location.

23. The method according to claim 22 wherein the remote location is a transaction privacy clearing house.

24. The method according to claim 22 wherein the storage device is within the transaction device.

25. The method according to claim 22 wherein the storage device is outside the transaction device.

26. The method according to claim 22 further comprising pre-selecting the context data for distribution.
